(19) United States
(12) Patent Application Publication
(10) Pub. No.: US 2005/0207142 A1
(43) Pub. Date: Sep. 22, 2005

(54) Modular illuminating balloon

(75) Inventor: Pierre Chabert, Saint Martin d'Heres (FR)

Correspondence Address: OLIFF & BERRIDGE, PLC, P.O. BOX 19928, ALEXANDRIA, VA, 22320, US

(73) Assignee: AIRSTAR, LE CHAMP PRES FROGES (FR)

(21) Appl. No.: 11/080,632

(22) Filed: Mar. 16, 2005

(30) Foreign Application Priority Data
Mar. 19, 2004 (FR) 04 02857

(51) Int. Cl. F21V 33/00

(52) U.S. Cl. 362/101; 362/96

(57) ABSTRACT

The illuminating balloon comprises at least one standard module having an inflatable envelope housing an illuminating device. The envelope of each standard module comprises external connecting means designed to co-operate, by juxtaposition according to a predefined shape, with the complementary external connecting means of a predetermined number of identical standard modules to adjust the global volume of the illuminating balloon. Each standard module is formed by two adjacent flat side faces and by a transverse surface. The external connecting means of each standard module comprise lateral connecting means fixed onto the contour of the flat side faces, and transverse connecting means fixed onto the transverse surface. The two flat side faces are substantially in the shape of an ellipse and the transverse surface is a curved revolution surface.

### BACKGROUND OF THE INVENTION

The invention relates to an illuminating balloon comprising at least one standard module having an inflatable envelope made of flexible material of small thickness, housing an illuminating device, means for support and power supply of the illuminating device and means for filling the envelope with a fluid.

### STATE OF THE ART

An illuminating balloon is constituted by a standard module generally comprising an inflatable envelope made of flexible material of small thickness, housing an illuminating device, means for support and power supply of the illuminating device and means for filling the envelope with a fluid. In the case of a non-tight illuminating balloon, the fluid is generally air, as described in the Patent FR-A-2754040. In the case of an air-tight illuminating balloon described for example in the document FR-A-2719228, the balloon is filled with a lifting gas, in particular helium. Such an illuminating balloon can for example be of spherical, elliptic or tubular shape.

The lighting power of the illuminating balloon depends on the power of the bulb and on the internal volume. Depending on the required applications, it is necessary to vary the power of the illuminating balloon. A first solution consists in changing the size of the illuminating balloon, but this requires purchasing several types of balloons, of more or less large size, which generates high costs. Another solution consists in modifying the capacity of the illuminating device of the balloon, but this gives rise to problems of handling, of adjustment and above all of safety.

### OBJECT OF THE INVENTION

The object of the invention is to remedy these shortcomings and to provide an illuminating balloon of modular structure with variable power.

According to the invention, this object is achieved by the fact that the envelope of each standard module comprises external connecting means designed to co-operate, by juxtaposition, with the complementary external connecting means of at least one identical standard module to form an illuminating balloon having a volume and a lighting power proportional to the number of juxtaposed standard modules, said external connecting means enabling the standard modules to be juxtaposed in a plurality of assemblies of different shapes.

According to a development of the invention, each standard module is formed by two adjacent flat side faces defining a first assembly angle, and by a transverse surface, joining the two flat side faces over the whole of their contour and defining second and third assembly angles therewith.

According to another development of the invention, the external connecting means of each standard module comprise lateral connecting means fixed onto the contour of the flat side faces, and transverse connecting means fixed onto the transverse surface.

According to a preferred embodiment, the two flat side faces are substantially in the shape of an ellipsis, the transverse surface being a curved revolution surface.

### BRIEF DESCRIPTION OF THE DRAWINGS

Other advantages and features will become more clearly apparent from the following description of the particular embodiment of the invention given as a non-restrictive example only and represented in the accompanying drawings, in which:

FIGS. 1 and 2 are respectively top and perspective views of the particular embodiment of a standard module of an illuminating balloon according to the invention.

FIGS. 3a to 11a represent, in perspective, different forms of an illuminating balloon comprising several standard modules according to FIGS. 1 and 2.

FIGS. 3b to 11b represent, in top view, the different forms of the illuminating balloon according to FIGS. 3a to 11a.

### DESCRIPTION OF A PARTICULAR EMBODIMENT

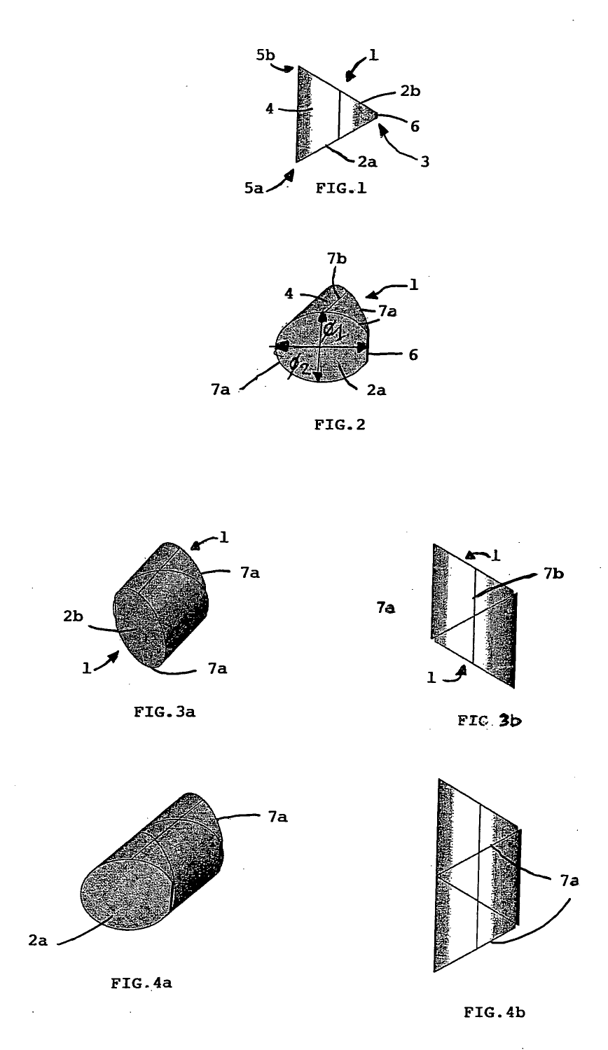

In FIGS. 1 and 2, a standard module 1 of an illuminating balloon comprises two adjacent flat side faces 2a, 2b defining a first assembly angle 3. The two side faces 2a, 2b are joined, over the whole of their contour, by a transverse surface 4, which defines, with the two side faces 2a, 2b, a second 5a and a third 5b assembly angles. The angle between the two flat side faces 2a, 2b is chosen so that the standard module 1 has substantially the shape of a quarter of a hexagon.

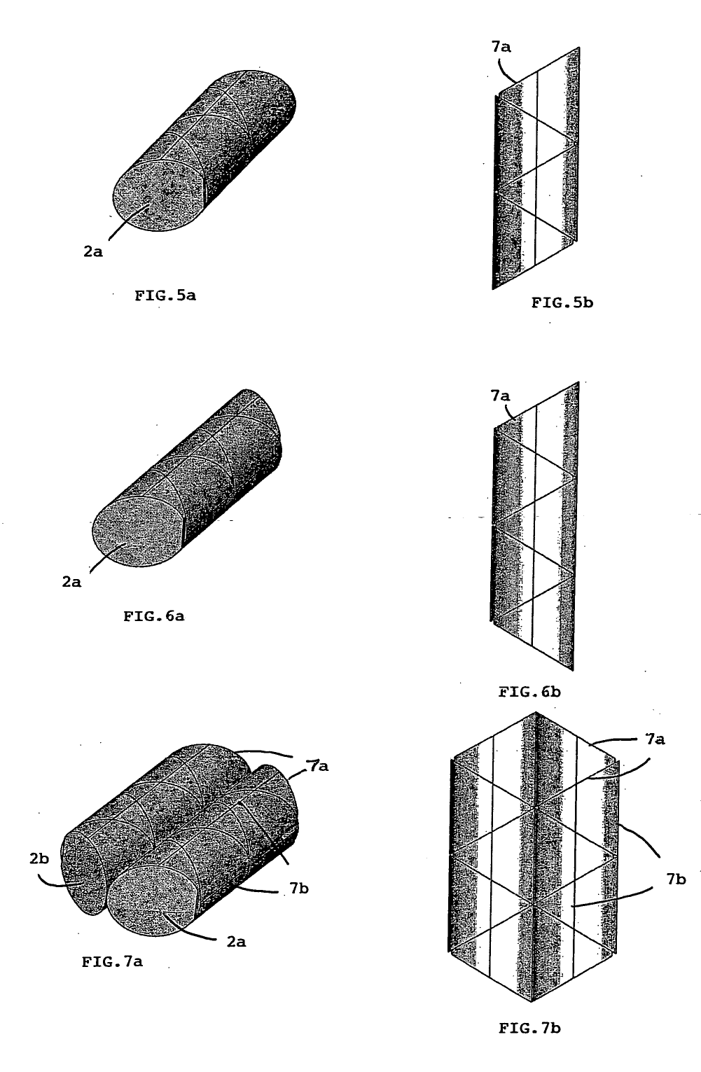

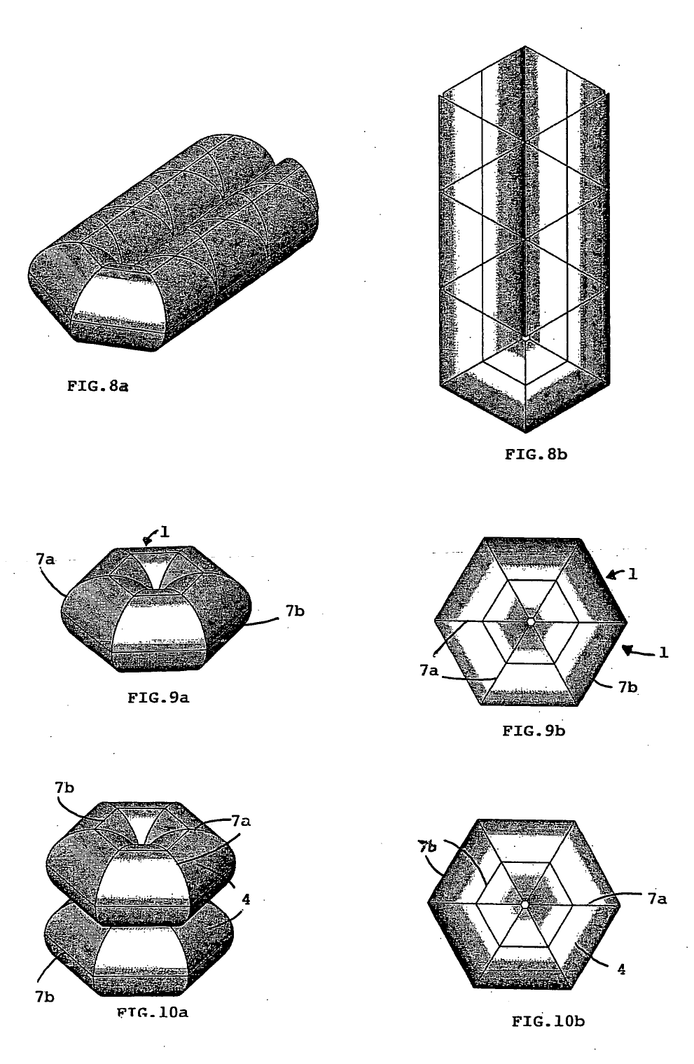

The first assembly angle 3 preferably comprises a chamfer 6 forming a flat surface at the level of this first assembly angle 3. The main function of this flat surface is to make easier the assembly of several standard modules 1, in the case of an illuminating balloon represented in FIGS. 3 to 11.

The two side faces 2a, 2b are substantially in the shape of an ellipse and the transverse surface 4 is a curved revolution surface which follows the contour of the flat faces 2a, 2b. For example purposes, the length φ1 of the small axis of the ellipse is about 2.2 m and the length φ2 of the large axis of the ellipse is about 2.5 m (FIG. 2).

The standard module 1 comprises lateral external connecting means 7a and transverse external connecting means 7b, designed to cooperate with the complementary external connecting means 7a, 7b of one or more identical standard modules 1 associated with the first one. All the standard modules 1 are then assembled according to a predefined shape, for example those that are represented in FIGS. 3 to 11, to form an illuminating balloon with a more or less large global volume. For example purposes, the external connecting means 7a, 7b can be composed of chains of zips.

The lateral connecting means 7a are fixed onto the whole of the contour of the side faces 2a, 2b and the transverse connecting means 7b are fixed onto the curved surface 4, preferably at the level of the ends of the small axis and of the large axis of the side faces 2a, 2b. The standard module 1 thus comprises three transverse connecting zones, i.e. on each side of the small axis of the side faces 2a, 2b and at the end opposite to the chamfer 6 of the large axis of the side faces 2a, 2b.

In FIGS. 3a to 7a and 3b to 7b, different examples of assembly of the illuminating balloon are represented. The standard modules 1 are joined one after the other by their flat faces 2a, 2b, the flat face 2a of a standard module 1 coming into contact with the flat face 2a of the next standard module 1. The standard modules 1 are therefore aligned in quincunx manner to form a substantially cylindrical illuminating balloon. It is then the lateral connecting means 7a that are used to perform joining between the different standard modules 1.

It is possible to associate two illuminating balloons according to FIGS. 6a and 6b to form an illuminating balloon according to FIGS. 7a and 7b. Joining is then performed by the transverse connecting means 7b of the curved surfaces 4, situated at the level of the large axis of the flat faces 2a, 2b.

In FIGS. 9a and 9b, six standard modules 1 are joined to form an illuminating balloon of hexagonal shape. The standard modules 1 are joined via their flat faces 2a, 2b, the flat face 2a of a standard module 1 coming into contact with the flat face 2b of the next standard module 1. The standard modules 1 are thus joined by their lateral connecting means 7a.

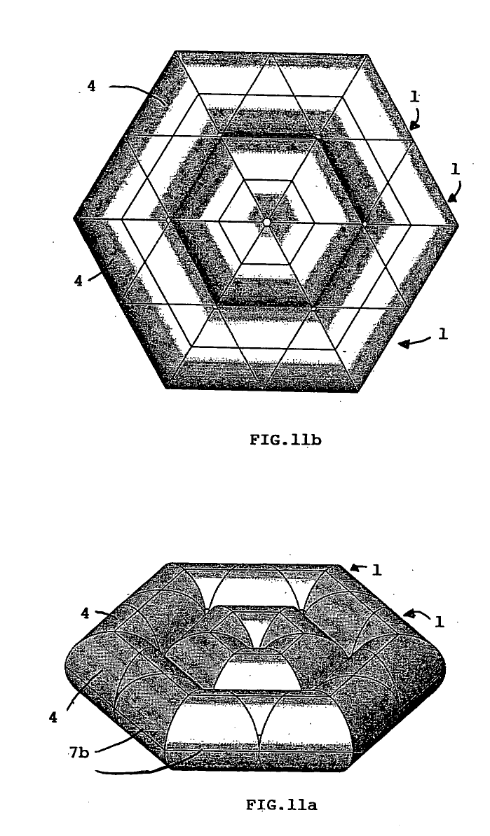

As represented in FIGS. 10a, 10b and 11a, 11b, it is possible to create an illuminating balloon with a more complex shape, to increase its lighting power. For example, two assemblies according to FIGS. 9a and 9b are associated to form a double illuminating balloon with superposed hexagons and joined by their transverse connecting means 7b, situated at the level of the small axis of the flat faces 2a, 2b (FIGS. 10a, 10b). It is thus possible to superpose several hexagons according to the same principle to obtain an illuminating balloon with a large power, with a relatively large height.

In FIGS. 11a and 11b, an assembly according to FIGS. 9a, 9b is inserted in the heart of another assembly made up beforehand, in order to form an illuminating balloon still of substantially hexagonal shape with a relatively large width. The two assemblies are then joined by their transverse connecting means 7b, situated at the level of the large axis of the side faces 2a, 2b.

In all cases, the internal volume of a standard module 1 being constant, juxtaposition of all the standard modules 1 enables the global volume of the illuminating balloon, and consequently its lighting power thereof, to be increased. Due to the external connecting means 7a, 7b present on each face of a standard module 1, the different configurations of the juxtaposed standard modules 1 thus make it possible to optimize the modularity of the illuminating balloon, i.e. its volume and its lighting power, by offering a multitude of assembly possibilities of different shapes. The main advantage of this illuminating balloon therefore lies in the fact that the lighting power of the illuminating balloon is proportional, for each application, to the number of standard modules 1 chosen.

The invention is not limited to the embodiment described above. Particularly, the zips can be replaced by other quick closing means, in particular with eyelets or detachable fastening tapes. The size of the standard module 1 can vary according to the applications and the side faces 2a, 2b of the standard module 1 can take another shape, for example square, rectangular or round.

Furthermore, each standard module 1 can comprise fluid outlet means, in particular in the case of a hermetically sealed standard module 1. It is also possible to provide a standard module 1 with a light-reflecting tarpaulin to direct the lighting and adjust the lighting power of each standard module 1.

1. Illuminating balloon comprising at least one standard module having an inflatable envelope made of flexible material of small thickness, housing an illuminating device, means for support and power supply of the illuminating device and means for filling the envelope with a fluid, illuminating balloon wherein the envelope of each standard module comprises external connecting means designed to co-operate, by juxtaposition, with the complementary external connecting means of at least one identical standard module to form an illuminating balloon having a volume and a lighting power proportional to the number of juxtaposed standard modules, said external connecting means enabling the standard modules to be juxtaposed in a plurality of assemblies of different shapes.

2. Illuminating balloon according to claim 1, wherein each standard module is formed by two adjacent flat side faces defining a first assembly angle, and by a transverse surface joining the two flat side faces over the whole of their contour and defining second and third assembly angles therewith.

3. Illuminating balloon according to claim 2, wherein the first assembly angle of each standard module comprises a chamfer so as to form a flat surface at the level of the first assembly angle.

4. Illuminating balloon according to claim 2, wherein the external connecting means of each standard module comprise lateral connecting means fixed onto the contour of the flat side faces, and transverse connecting means fixed onto the transverse surface.

5. Illuminating balloon according to claim 2, wherein the two flat side faces are substantially in the form of an ellipse, the transverse surface being a curved revolution surface.

6. Illuminating balloon according to claim 5, wherein the length of the small axis of the ellipse is about 2.2 m and the length of the large axis of the ellipse is about 2.5 m.

7. Illuminating balloon according to claim 6, wherein the transverse connecting means are fixed onto the curved surface of each standard module, at the level of the small axis and of the large axis of the flat side faces.

8. Illuminating balloon according to claim 1, wherein the external connecting means are composed of chains of zips.

9. Illuminating balloon according to claim 1, wherein each standard module comprises fluid outlet means.
